(19) United States
(12) Patent Application Publication
(10) Pub. No.: US 2025/0184382 A1
(43) Pub. Date: Jun. 5, 2025

(54) METHOD, APPARATUS, AND MEDIUM FOR VISUAL DATA PROCESSING

(71) Applicant: Douyin Vision Co., Ltd., Beijing (CN)

(72) Inventor: Deping LI, Beijing (CN)

(21) Appl. No.: 19/048,710

(22) Filed: Feb. 7, 2025

Related U.S. Application Data
(63) Continuation of application No. PCT/CN2023/097636, filed on May 31, 2023.

(30) Foreign Application Priority Data
Aug. 8, 2022 (WO) PCT/CN2022/110854

(51) Int. Cl. H04L 65/70; H04L 9/40; H04L 65/65; H04N 19/577

(52) U.S. Cl. CPC H04L 65/70; H04L 63/0457; H04L 65/65; H04N 19/577

(57) ABSTRACT

Embodiments of the present disclosure provide a solution for visual data processing. A method for visual data processing is proposed. The method comprises: performing a conversion between a bitstream of a current frame of visual data and at least one packet in accordance with a real-time transport protocol (RTP), wherein the at least one packet comprises a first indication indicating a difference between a decoding timestamp of the current frame and a presentation timestamp of the current frame.

### CROSS REFERENCE TO RELATED APPLICATIONS

This application is a continuation of International Application No. PCT/CN2023/097636, filed on May 31, 2023, which claims the benefit of International Application No. PCT/CN2022/110854, filed on Aug. 8, 2022. The entire contents of these applications are hereby incorporated by reference in their entireties.

### FIELDS

Embodiments of the present disclosure generally relate to computer technologies, and particularly, to visual data processing and transmission technologies.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding.

Real-time transport protocol (RTP) is a standardized packet format for delivering multimedia data over Internet Protocol (IP) networks and is optimized for consistent delivery of live data. It is used in internet telephony, Voice over IP and video telecommunication. As visual data codec, such as visual data codec based on AVC or HEVC, is widely used in RTP-based system, it is desired to adapt the RTP-based system to the visual data codec, so as to support the state-of-the-art visual data coding technology.

### SUMMARY

Embodiments of the present disclosure provide a solution for visual data processing.

In a first aspect, a method for visual data processing is proposed. The method comprises: performing a conversion between a bitstream of a current frame of visual data and at least one packet in accordance with a real-time transport protocol (RTP), wherein the at least one packet comprises a first indication indicating a difference between a decoding timestamp of the current frame and a presentation timestamp of the current frame.

Based on the method in accordance with the first aspect of the present disclosure, a first indication may be added into the packet based on RTP, so as to convey a difference between a decoding timestamp of the current frame and a presentation timestamp of the current frame. In aid of the first indication, an RTP-based system can decode visual data with bi-directional predicted frames (B-frames) correctly. Compared with the conversion solutions where only intra-coded frames (I-frames) and predicted frames (P-frames) are supported by an RTP-based system, the proposed method can advantageously enable the RTP-based system to support B-frames and thus improve the compatibility with the state-of-the-art visual data coding technology.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a current frame of visual data which is generated by a method performed by an apparatus for visual data processing. The method comprises: performing a conversion between the bitstream and at least one packet in accordance with a real-time transport protocol (RTP), wherein the at least one packet comprises a first indication indicating a difference between a decoding timestamp of the current frame and a presentation timestamp of the current frame.

In a fifth aspect, a method for storing a bitstream of a current frame of visual data is proposed. The method comprises: performing a conversion between the bitstream and at least one packet in accordance with a real-time transport protocol (RTP); storing the bitstream in a non-transitory computer-readable recording medium, wherein the at least one packet comprises a first indication indicating a difference between a decoding timestamp of the current frame and a presentation timestamp of the current frame.

In a sixth aspect, a further non-transitory computer-readable recording medium is proposed. The non-transitory computer-readable recording medium stores at least one packet which is generated by a method performed by an apparatus for visual data processing. The method comprises: performing a conversion between a bitstream of a current frame of visual data and the at least one packet in accordance with a real-time transport protocol (RTP), wherein the at least one packet comprises a first indication indicating a difference between a decoding timestamp of the current frame and a presentation timestamp of the current frame.

In a seventh aspect, a method for storing at least one packet is proposed. The method comprises: performing a conversion between a bitstream of a current frame of visual data and the at least one packet in accordance with a real-time transport protocol (RTP); storing the at least one packet in a non-transitory computer-readable recording medium, wherein the at least one packet comprises a first indication indicating a difference between a decoding timestamp of the current frame and a presentation timestamp of the current frame.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example RTP-based system in accordance with some embodiments of the present disclosure;

FIG. 2 illustrates a block diagram that illustrates a first example video encoder in accordance with some embodiments of the present disclosure;

FIG. 3 illustrates a block diagram that illustrates an example video decoder in accordance with some embodiments of the present disclosure;

FIG. 4 illustrates an example of RTP header extension;

FIG. 5 illustrates an example extension element;

FIG. 6 illustrates an example header extension with three extension elements and some padding;

FIG. 7 illustrates an example of two-byte header;

FIG. 8 illustrates an example of an extension element;

FIG. 9 illustrates an example header extension with three extension elements and some padding;

FIG. 10 illustrates an extension format in accordance with some embodiments of the present disclosure;

FIG. 11 illustrates a schematic diagram of an example environment in which techniques for visual data processing in accordance with some embodiments of the present disclosure can be implemented;

FIG. 12 illustrates a signaling chart for visual data transmission according to some embodiments of the present disclosure;

FIG. 13 illustrates a flowchart of a method for visual data processing in accordance with embodiments of the present disclosure; and

FIG. 14 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”. “an” and “the” are intended to include the plural forms as well, unless the context clearly indicates otherwise. It will be further understood that the terms “comprises”. “comprising”. “has”. “having”. “includes” and/or “including”, when used herein, specify the presence of stated features, elements, and/or components etc., but do not preclude the presence or addition of one or more other features, elements, components and/or combinations thereof.

As used herein, the terms “MUST”. “REQUIRED” and “SHALL” mean that the definition is an absolute requirement of the specification. The terms “MUST NOT” and “SHALL NOT” mean that the definition is an absolute prohibition of the specification. The terms “SHOULD” and “RECOMMENDED” mean that there may exist valid reasons in particular circumstances to ignore a particular item, but the full implications must be understood and carefully weighed before choosing a different course. The terms “SHOULD NOT” and “NOT RECOMMENDED” mean that there may exist valid reasons in particular circumstances when the particular behavior is acceptable or even useful, but the full implications should be understood and the case carefully weighed before implementing any behavior described with this label. The terms “MAY” and “OPTIONAL” mean that an item is truly optional.

### Example Environment

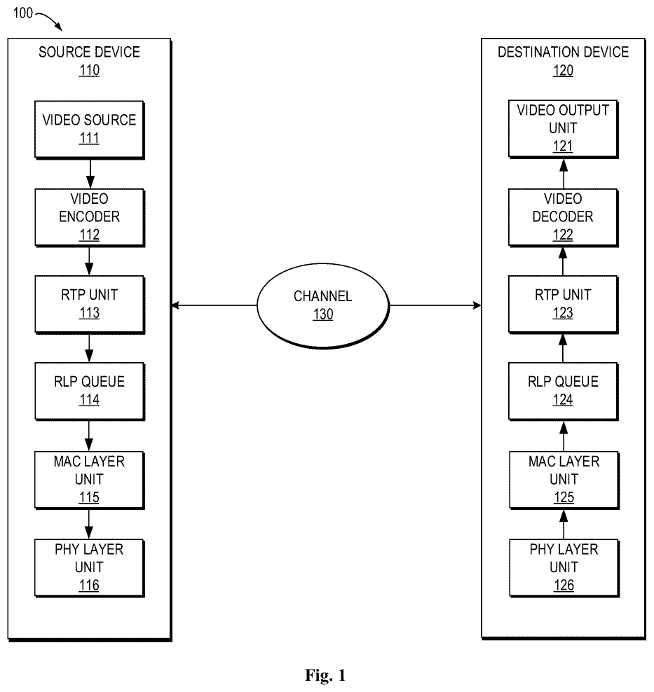

FIG. 1 is a block diagram that illustrates an example RTP-based system 100 that may utilize the techniques of this disclosure. It should be understood that the system 100 may also include additional blocks not shown, and/or blocks shown may be omitted. For purpose of illustration, FIG. 1 is described with reference to video processing. The techniques of this disclosure may also be applied to any other suitable system or any other suitable visual data, such as a series of images, or the like. The scope of the present disclosure is not limited in this respect.

As shown in FIG. 1, system 100 includes a source device 110, e.g., a sending device, which may be an eNB or a user equipment (UE), and a destination device 120, e.g., a receiving device, which may be a UE or an eNB, connected by a transmission channel 130, a wireless/wireline channel. In the example of FIG. 1, source device 110 may be associated with a first video communication device, e.g., an eNB, and includes a video source 111, video encoder 112, RTP conversion unit (also referred to as RTP unit) 113, radio link protocol (RLP) queue 114, MAC layer unit 115, and physical (PHY) layer unit 116. Destination device 120 may be associated with another video communication device, e.g., a UE, and includes a PHY layer unit 126, MAC layer unit 125, RLP queue 124, RTP unit 123, video decoder 122, and/or video output unit 121. It should be noted both network devices and UEs can be sending devices or receiving devices, and this figure is not intended to be a networking figure, as such, the channel is also not intended to be limited to a wireless channel.

System 100 may provide bi-directional video transmission, e.g., for video telephony via transmission channel 130. Accordingly, generally reciprocal encoding, decoding, and conversion units may be provided on opposite ends of channel 130. In some implementations, source device 110 and destination device 120 may be embodied within video communication devices such as wireless mobile terminals equipped for video streaming, video telephony, or both. The mobile terminals may support VT according to packet-switched standards such as RTP.

For example, at source device 110, RTP unit 113 adds appropriate RTP header data to video data received from video encoder 112 and places the data in RLP queue 114. In some examples, as described herein, RTP unit 113 conform to a particular standard, such as “RFC 3550: RTP: A Transport Protocol for Real-Time Applications,” H. Schulzrinne et al., July 2003, “RFC 5104: Codec Control Messages in the RTP Audio-Visual Provide with Feedback (AVPF),” S. Wenger et al., February 2008 (hereinafter RFC 5104), and/or other applicable standards for real-time or near real-time transport of data. MAC layer unit 115 generates MAC RLP packets from the contents of RLP queue 114. PHY layer unit 116 converts the MAC RLP packets into PHY layer packets for transmission over channel 130.

PHY layer unit 126 and MAC layer unit 125 of destination device 120 operate in a reciprocal manner. PHY layer unit 126 converts PHY layer packets received from channel 130 to MAC RLP packets. MAC layer unit 125 places the MAC RLP packets into RLP queue 124. RTP unit 123 strips the header information from the data in RLP queue 124, and reassembles the video data for delivery to video decoder 122.

System 100 may be designed to support one or more wireless communication technologies such as code division multiple access (CDMA), frequency division multiple access (FDMA), time division multiple access (TDMA), or orthogonal frequency divisional multiplexing (OFDM), or another suitable wireless technique. The above wireless communication technologies may be delivered according to any of a variety of radio access technologies. For example, CDMA may be delivered according to cdma2000 or wideband CDMA (WCDMA) standards. TDMA may be delivered according to the Global System for Mobile Communications (GSM) standard. The Universal Mobile Telecommunication System (UMTS) standard permits GSM or WCDMA operation. Typically, for VT applications, system 100 may be designed to support high data rate (HDR) technologies.

Video encoder 112 generates encoded video data according to a video compression method, such as MPEG-4, High Efficiency Video Coding (HEVC), or another video coding standard. Other video compression methods include the International Telecommunication Union (ITU) H.263, ITU H.264, or MPEG-2 methods.

In operation, RTP unit 113 obtains video packets from video encoder 112. As mentioned previously, RTP unit 113 adds appropriate header information to the video packets and inserts the resulting data within RLP queue 114. MAC layer unit 115 retrieves data from RLP queue 114 and forms MAC layer packets. Each MAC layer packet carries RTP header information and video packet data that is contained within RLP queue 114.

In many cases, the MAC layer packet will carry header information and video packet data, depending on the contents of RLP queue 114. The MAC layer packets may be configured according to a radio link protocol (RLP), and may be referred to as MAC RLP packets. PHY layer unit 116 converts the MAC RLP video packets into PHY layer packets for transmission across channel 130.

Channel 130 carries the PHY layer packets to destination device 120. Channel 130 may be any physical connection between source device 110 and destination device 120. For example, channel 130 may be a wired connection, such as a local or wide-area wired network. Alternatively, as described herein, channel 130 may be a wireless connection such as a cellular, satellite or optical connection. Channel conditions may be a concern for wired and wireless channels, but may be particularly pertinent for mobile VT applications performed over a wireless channel 16, in which channel conditions may suffer due to fading or congestion. Channel 130 may support a particular network link rate (e.g., a particular bandwidth), which may fluctuate according to channel conditions. For example, channel 130 may be characterized by a reverse link (RL) having a throughput that varies according to channel conditions.

In general, PHY layer unit 126 of destination device 120 identifies the MAC layer packets from the PHY layer packets and reassembles the content into MAC RLP packets. MAC layer unit 125 then reassembles the contents of the MAC RLP packets to provide video packets for insertion within RLP queue 124. RTP unit 123 removes the accompanying header information and provides video packets to video decoder 122. Video decoder 122 decodes the video data frames to produce a stream of video data for use in driving a display device.

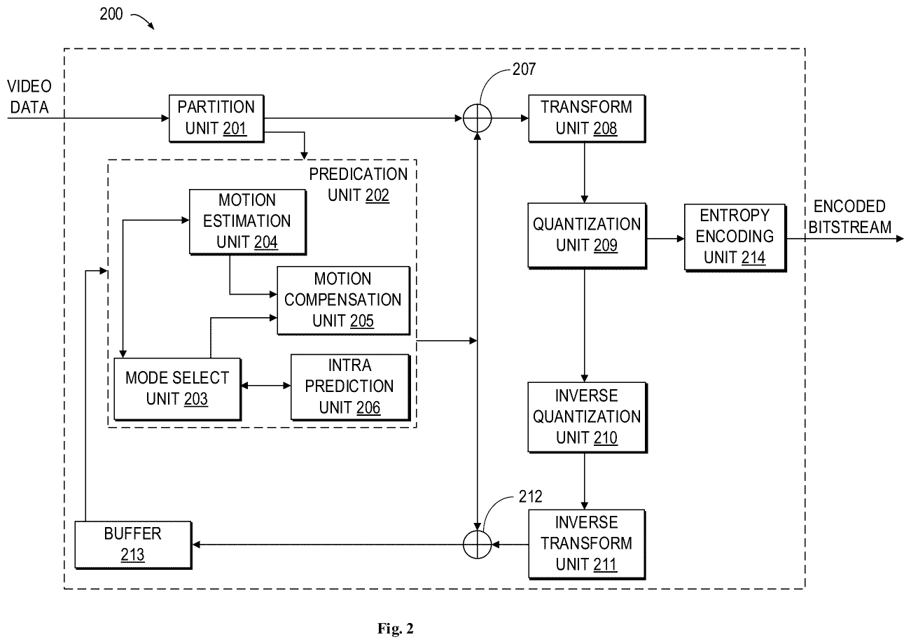

FIG. 2 is a block diagram illustrating an example of a video encoder 200, which may be an example of the video encoder 112 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

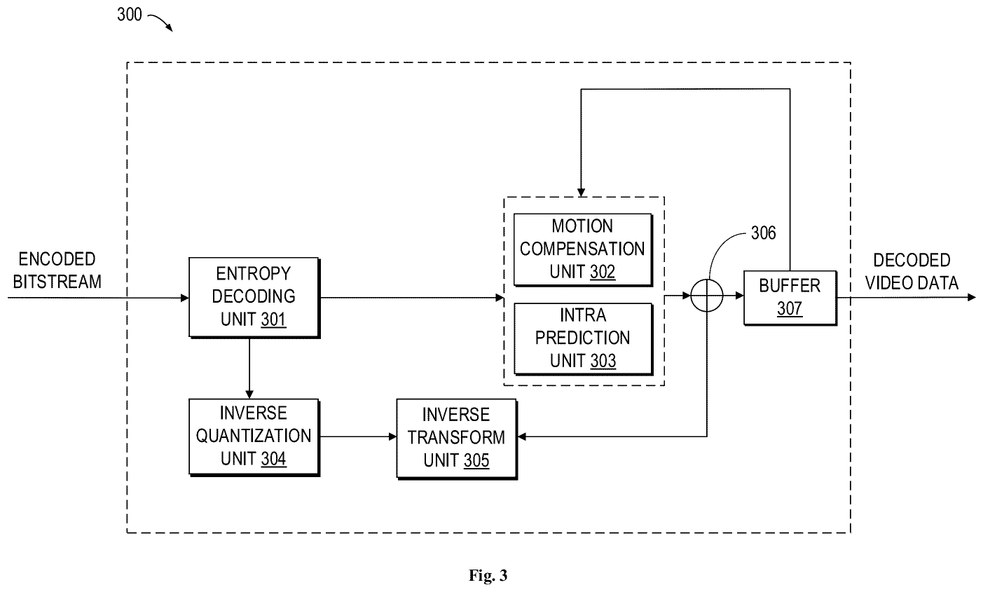

FIG. 3 is a block diagram illustrating an example of a video decoder 300, which may be an example of the video decoder 122 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure describes an RTP header extension used to convey decoding time information about video when Bi-directional predicted frames exist. It adds Composition Time (CTS) as value so that receiver can decode video with correct sequence.

### 2. Introduction

As video codec, H264/HEVC is widely used in RTP base system. Those codec support I-Frame, B-Frame, and P-frame. Most RTP systems do not support B-Frame, while B-Frame is widely used in streaming systems, with the rapid deploy of Real Time Communication (RTC) in low latency streaming scenario, support for Bi-directional predicted frames in RTP base systems are necessary.

### 2.1 RTP Header Extension

An extension mechanism is provided to allow individual implementations to experiment with new payload-format-independent functions that require additional information to be carried in the RTP data packet header. This mechanism is designed so that the header extension may be ignored by other interoperating implementations that have not been extended.

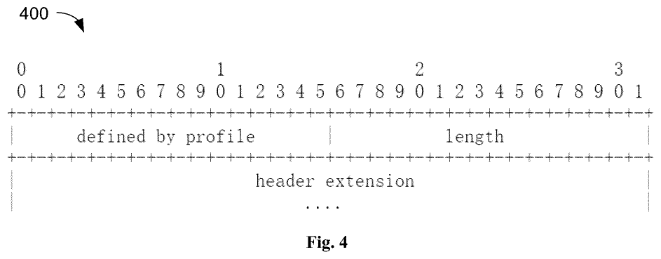

FIG. 4 illustrates an example of RTP header extension. Note that this header extension is intended only for limited use. Most potential uses of this mechanism would be better done another way, using the methods described in the previous section. For example, a profile-specific extension to the fixed header is less expensive to process because it is not conditional nor in a variable location. Additional information required for a particular payload format SHOULD NOT use this header extension, but SHOULD be carried in the payload section of the packet. If the X bit in the RTP header is one, a variable-length header extension MUST be appended to the RTP header, following the CSRC list if present. The header extension contains a 16-bit length field that counts the number of 32-bit words in the extension, excluding the four-octet extension header (therefore zero is a valid length). Only a single extension can be appended to the RTP data header. To allow multiple interoperating implementations to each experiment independently with different header extensions, or to allow a particular implementation to experiment with more than one type of header extension, the first 16 bits of the header extension are left open for distinguishing identifiers or parameters. The format of these 16 bits is to be defined by the profile specification under which the implementations are operating. This RTP specification does not define any header extensions itself.

### 2.2 Header Extension Type Considerations

Each extension element in a packet has a local identifier (ID) and a length. The local identifiers present in the stream MUST have been negotiated or defined out of band. There are no static allocations of local identifiers. Each distinct extension MUST have a unique ID. The ID value 0 is reserved for padding and MUST NOT be used as a local identifier.

An extension element with an ID value equal to 0 MUST NOT have an associated length field greater than 0. If such an extension element is encountered, its length field MUST be ignored, processing of the entire extension MUST terminate at that point, and only the extension elements present prior to the element with ID 0 and a length field greater than 0 SHOULD be considered.

There are two variants of the extension: one-byte and two-byte headers. Since it is expected that (a) the number of extensions in any given RTP session is small and (b) the extensions themselves are small, the one-byte header form is preferred and MUST be supported by all receivers. A stream MUST contain only one-byte headers or only two-byte headers unless it is known that all recipients support mixing, by either SDP Offer/Answer negotiation or out-of-band knowledge. Each RTP packet with an RTP header extension following this specification will indicate whether it contains one-byte or two-byte header extensions through the use of the “defined by profile” field. Extension element types that do not match the header extension format, i.e., one-byte or two-byte, MUST NOT be used in that RTP packet. Transmitters SHOULD NOT use the two-byte header form when all extensions are small enough for the one-byte header form. Transmitters that intend to send the two-byte form SHOULD negotiate the use of IDs above 14 if they want to let the receivers know that they intend to use the two-byte form—for example, if the RTP header extension is longer than 16 bytes. A transmitter may be aware that an intermediary may add RTP header extensions; in this case, the transmitter SHOULD use the two-byte form.

A sequence of extension elements, possibly with padding, forms the header extension defined in the RTP specification. There are as many extension elements as will fit in the RTP header extension, as indicated by the RTP header extension length. Since this length is signaled in full 32-bit words, padding bytes are used to pad to a 32-bit boundary. The entire extension is parsed byte by byte to find each extension element (no alignment is needed), and parsing stops (1) at the end of the entire header extension or (2) in the “one-byte headers only” case, on encountering an identifier with the reserved value of 15—-whichever happens earlier.

In both forms, padding bytes have the value of 0 (zero). They MAY be placed between extension elements, if desired for alignment, or after the last extension element, if needed for padding. A padding byte does not supply the ID of an element, nor does it supply the length field. When a padding byte is found, it is ignored, and the parser moves on to interpreting the next byte.

Note carefully that the one-byte header form allows for data lengths between 1 and 16 bytes, by adding 1 to the signaled length value (thus, 0 in the length field indicates that one byte of data follows). This allows for the important case of 16-byte payloads. This addition is not performed for the two-byte headers, where the length field signals data lengths between 0 and 255 bytes.

Use of RTP header extensions will reduce the efficiency of RTP header compression, since the header extension will be sent uncompressed unless the RTP header compression module is updated to recognize the extension header.

### 2.3 One-Byte Header

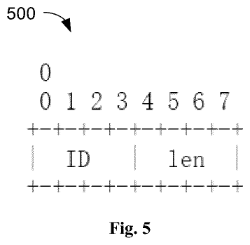

In the one-byte header form of extensions, the 16-bit value required by the RTP specification for a header extension, labeled in the RTP specification as “defined by profile”, MUST have the fixed bit pattern 0×BEDE (the pattern was picked for the trivial reason). FIG. 5 illustrates an example extension element. As shown in FIG. 5, each extension element MUST start with a byte containing an ID and a length.

The 4-bit ID is the local identifier of this element in the range 1-14 inclusive. In the signaling section, this is referred to as the valid range. The local identifier value 15 is reserved for a future extension and MUST NOT be used as an identifier. If the ID value 15 is encountered, its length field MUST be ignored, processing of the entire extension MUST terminate at that point, and only the extension elements present prior to the element with ID 15 SHOULD be considered.

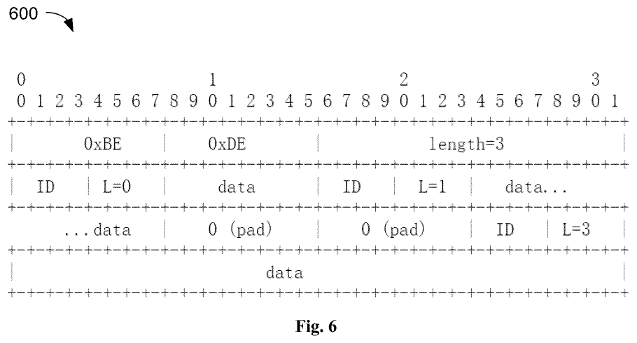

The 4-bit length is the number, minus one, of data bytes of this header extension element following the one-byte header. Therefore, the value zero (0) in this field indicates that one byte of data follows, and a value of 15 (the maximum) indicates element data of 16 bytes. (This permits carriage of 16-byte values, which is a common length of labels and identifiers, while losing the possibility of zero-length values, which would often be padded anyway.) FIG. 6 illustrates an example header extension, with three extension elements and some padding.

### 2.4 Two-Byte Header

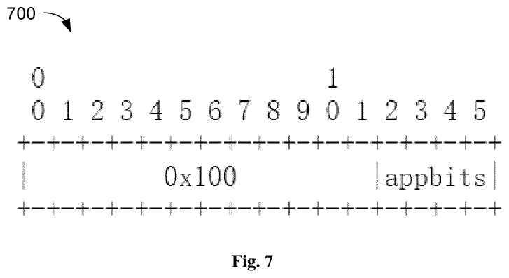

In the two-byte header form, the 16-bit value defined by the RTP specification for a header extension, labeled in the RTP specification as “defined by profile”, is defined as shown in FIG. 7. FIG. 7 illustrates an example of two-byte header.

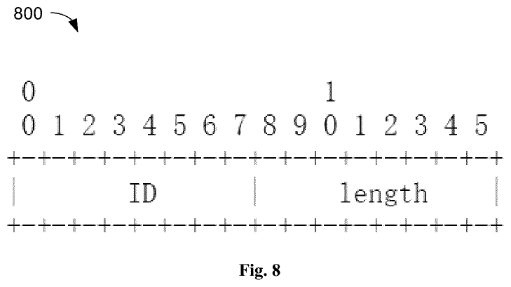

The appbits field is 4 bits that are application dependent and MAY be defined to be any value or meaning; this topic is outside the scope of this specification. For the purposes of signaling, this field is treated as a special extension value assigned to the local identifier 256. If no extension has been specified through configuration or signaling for this local identifier value (256), the appbits field SHOULD be set to all 0s (zeros) by the sender and MUST be ignored by the receiver. FIG. 8 illustrates an example of an extension element. As shown in FIG. 8, each extension element starts with a byte containing an ID and a byte containing a length.

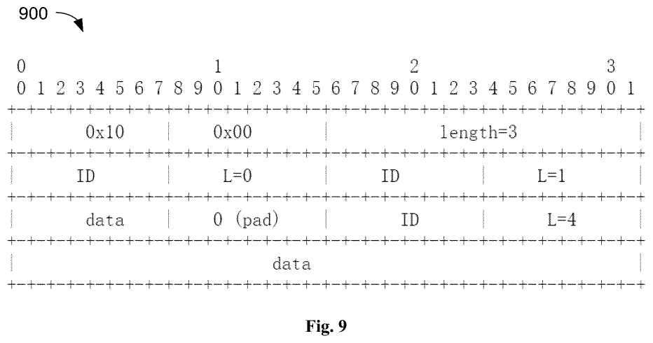

The 8-bit ID is the local identifier of this element in the range 1-255 inclusive. In the signaling section, the range 1-256 is referred to as the valid range, with the values 1-255 referring to extension elements and the value 256 referring to the 4-bit appbits field (above). Note that there is one ID space for both the one-byte form and the two-byte form. This means that the lower values (1-14) can be used in the 4-bit ID field in the one-byte header format with the same meanings. The 8-bit length field is the length of extension data in bytes, not including the ID and length fields. The value zero (0) indicates that there is no subsequent data. FIG. 9 illustrates an example header extension, with three extension elements and some padding.

### 2.5 RTP Header SDP Signal Design

The indication of the presence of this extension, and the mapping of local identifiers used in the header extension to a larger namespace, MUST be performed out of band—for example, as part of an SDP Offer/Answer. This section defines such signaling in SDP.

A usable mapping MUST use IDs in the valid range, and each ID in this range MUST be used only once for each media section (or only once if the mappings are session level). Mappings that do not conform to these rules MAY be presented, for instance, during SDP Offer/Answer negotiation as described in the next section, but remapping to conformant values is necessary before they can be applied.

Each extension is named by a URI. That URI MUST be absolute; it precisely identifies the format and meaning of the extension. URIs that contain a domain name SHOULD also contain a month-date in the form mmyyyy. The definition of the element and assignment of the URI MUST have been authorized by the owner of the domain name on or very close to that date. (This avoids problems when domain names change ownership.) If the resource or document defines several extensions, then the URI MUST identify the actual extension in use, e.g., using a fragment or query identifier (characters after a “#” or “?” in the URI).

Rationale: The use of URIs provides for a large, unallocated space and gives documentation on the extension. The URIs do not have to be dereferencable, in order to permit confidential or experimental use, or to cover the case when extensions continue to be used after the organization that defined them ceases to exist.

An extension URI with the same attributes MUST NOT appear more than once applying to the same stream, i.e., at session level or in the declarations for a single stream at media level. (The same extension can, of course, be used for several streams and can appear with different <extensionattributes> for the same stream.). For extensions defined in RFCs, the URI used SHOULD be a URN starting with “urn:ietf:params:rtp-hdrext:” followed by a registered, descriptive name. The registration requirements are detailed in IANA Considerations.

An example where “avt-example-metadata” is the hypothetical name of a header extension might be:
urn:ietf:params:rtp-hdrext:avt-example-metadata.

An example name not from the IETF might be:
http://example.com/082005/ext.htm #example-metadata.

The mapping MAY be provided per media stream (in the media-level section(s) of SDP, i.e., after an “m=” line) or globally for all streams (i.e., before the first “m=” line, at session level). The definitions MUST be either all session level or all media level; it is not permitted to mix the two styles. In addition, as noted above, the IDs used MUST be unique in each media section of the SDP or unique in the session for session-level SDP declarations.

Each local identifier potentially used in the stream is mapped to an extension identified by a URI using an attribute of the form:
a=extmap: <value> [“/”<direction>]<URI><extensionattributes>
   where <value> is the local identifier (ID) of this extension and is an integer in the valid range (0 is reserved for padding in both forms, and 15 is reserved in the one-byte header form, as noted above); <direction> is one of “sendonly”, “recvonly”, “sendrecv”, or “inactive” (without the quotes) with relation to the device being configured; <URI> is a URI, as above. The formal BNF syntax is presented in the related specification.

Example: a=extmap: 1 http://example.com/082005/ext.htm #ttime
a=extmap: 2/sendrecv http://example.com/082005/ext.htm #xmeta short
   When SDP signaling is used for the RTP session, it is the presence of the “extmap” attribute(s) that is diagnostic that this style of header extensions is used, not the magic number (“BEDE” or “100”) indicated above.

### 3. Problems

Video streams contain a lot of details, including timestamps, so a decoder knows how to handle the content properly. The DTS (Decoding TimeStamp) decides when a frame has to be decoded, while the PTS (Presentation TimeStamp) describes when a frame has to be presented. This difference becomes important when using B-frames, which are frames that can have references to frames in the past, but also to frames in the future. Given that, there will be frames in the future, which a decoder needs to decode first in order to use them as reference. Therefore, decoder needs DTS when B-frames exist, while, the RTP timestamp reflects the presentation time (PTS) only.

This disclosure specifies an RTP extension header that allows video RTP senders deliver CTS (Composition Time) to RTP receiver, The CTS value is PTS minus DTS. Therefore, the RTP receiver gets DTS value via RTP timestamp adding CTS value. This new header extension uses the general mechanism for RTP header extensions. RTP sender only needs to add CTS to the first RTP packet when the video frame contains several packets, which reduces overhead.

### 4. Embodiments

### Terminology

RTP: Real-time Transport Protocol
RTCP: RTP Control Protocol
RTCP RR: RTCP Receiver Report
RTCP SR: RTCP Sender Report
SDP: Session Description Protocol
Clock Rate: The multiplier used to convert from a wallclock value in seconds to an equivalent RTP timestamp value (without the fixed random offset). Note that various terms like “clock frequency”, “media clock rate”, “timestamp unit”, “timestamp frequency”, and “RTP timestamp clock rate” may be used as synonymous to clock rate.
RTP Sender: A logical network element that sends RTP packets, sends RTCP SR packets, and receives RTCP reception report blocks.
RTP Receiver: A logical network element that receives RTP packets, receives RTCP SR packets, and sends RTCP reception report blocks.
RTC: Real Time Communication
PTS: Video Presentation TimeStamp
DTS: Video Decoding TimeStamp
CTS: Video Composition Time

### 4.1 RTP Header Extension Format

The general RTP payload format follows the RTP header format and generic RTP header extensions, RTP header extension MAY encoded using the one-byte header or two-byte header as described above. The one-byte header format is used as an example in this disclosure.

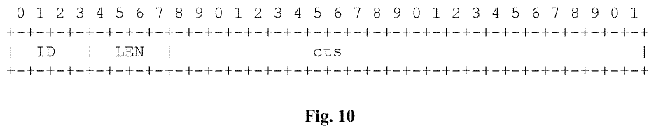

The following RTP header extension is RECOMMENDED. The ID is assigned per ([RFC8285]), and format is shown in FIG. 10, which illustrates an extension format according to some embodiments of the present disclosure. In the example shown in FIG. 10, ID represents extension id, and CTS is equal to PTS minus DTS and divided by 90 (Video Clock Rate).

### 4.2. Video RTP Sender

The video sender here MAY be video client or middle box perform RTP switch. Video client MAY encode video with B-frame, it SHOULD add this RTP header extension in the RTP packetization module. Only adding in the first RTP packet is RECOMMENDED when the video frame contains multi RTP packets, which will reduce overhead. The middle box MAY perform RTMP or other streaming video protocols translate to RTP streams work, it SHOULD add this header extension when streaming video contains B-frame.

### 4.3. Video RTP Receiver

The video RTP receiver here is a client which decodes video. It SHOULD extract CTS value when this extension exists, and calculate DTS value with RTP timestamp (PTS) and CTS. DTS=PTS-CTS*90, wherein 90 is video clock rate, Video receiver construction frame and put to jitter buffer, decoder MUST decode frame by DTS sequence, and video render module MUST render the decoded frame with PTS sequence, which come from RTP timestamp.

### 4.4. Usage Considerations

In practice, when receiver that decode video does not support B-frame, In order to successfully decode an incoming video stream, it is RECOMMENDED An RTP middle box discard B-frame when video RTP sender contains B-frame, the decoder at the Endpoint SHOULD add whether it support video B-frame capability in SDP payload format specific paramaters (a=fmtp), and follow the Offer/Answer procedure describe in ([RFC8285]).

### 4.5. Security Considerations

The security considerations of the RTP specification ([RFC3550]) and the general mechanism for RTP header extensions ([RFC8285]) apply. and all the security considerations of typologies ([RFC7667]) ([RFC7201]) for these two types of RTP intermediaries are applicable to this header extension. Security considerations for SDP are described in the corresponding section in ([RFC8866]). In the Secure Real-time Transport Protocol (SRTP) ([RFC3711]), RTP header extensions are authenticated but not encrypted. When this header extension is used, CTS are therefore visible on a frame-by-frame basis to an attacker passively observing the video stream. In scenarios where this is a concern, additional mechanisms MUST be used to protect the confidentiality of the header extension. This mechanism could be header extension encryption ([RFC6904]), or a lower-level security and authentication mechanism such as IPsec ([RFC4301]).

### 4.6 Session Description Protocol (SDP) Signaling

The URI for declaring this header extension in an extmap attribute is “urn:ietf:params:rtp-hdrext:CompositionTime”. It does not contain any extension attributes. It follows the standard mechanism described in ([RFC8285]). An example attribute line in SDP is as follows: a=extmap: 19 uri:ietf: rtc:rtp-hdrext: video: CompositionTime. The entire contents of the above-mentioned standard document (such as RFC8285, RFC3550, etc.) is hereby incorporated in its entirety.

More details of the embodiments of the present disclosure will be described below, which are related to visual data processing and transmission technologies.

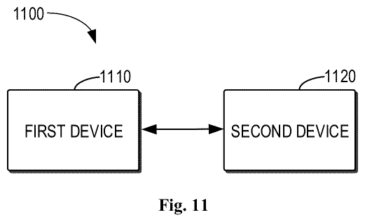

For purpose of discussion, FIG. 11 illustrates a schematic diagram of an example environment 1100 in which techniques for visual data processing in accordance with some embodiments of the present disclosure can be implemented. As shown in FIG. 11, the environment 1100 comprises a first device 1110 and a second device 1120. The first device 1110 and the second device 1120 may be communicatively coupled. By way of example rather than limitation, the first device 1110 and the second device 1120 may be coupled by a network, which may be the Internet.

In some embodiments, the first device 1110 may be an RTP sender, which may be an example of the RTP unit 113 in the system 100 illustrated in FIG. 1. Furthermore, the second device 1120 may be an RTP receiver, which may be an example of the RTP unit 123 in the system 100 illustrated in FIG. 1. By way of example, the first device 1110 and/or the second device 1120 may conform to a particular standard, such as RFC 3550, RFC 5104 and/or other applicable standards for real-time or near real-time transport of data.

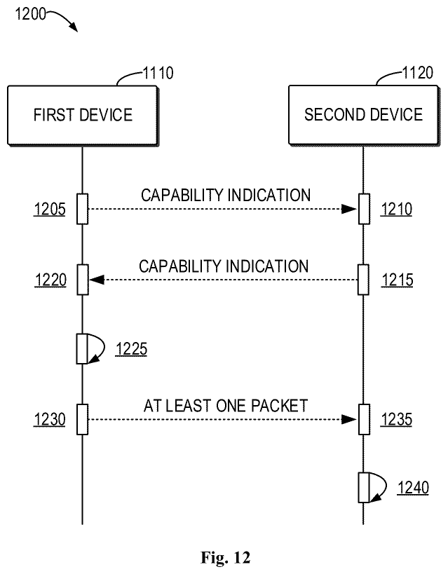

FIG. 12 illustrates a signaling chart 1200 for visual data transmission according to some embodiments of the present disclosure. The signaling chart 1200 involves the first device 1110, and the second device 1120.

In operation, the first device 1110 encapsulates 1225 a bitstream of a current frame of the visual data into at least one packet associated with the current frame. By way of example rather than limitation, the visual data may be a video, a series of images, a multimedia file, or the like. In some embodiments, the current frame is a B-frame. It should be understood that the current frame may also be any other suitable frame, such as an I-frame or P-frame. The scope of the present disclosure is not limited in this respect.

The at least one packet comprises a first indication indicating a difference between a decoding timestamp of the current frame and a presentation timestamp of the current frame. The at least one packet may also comprise any other suitable information related to the current frame. It should be understood that the at least one packet may also comprise any other suitable information irrelated to the current frame, such as information related to a further frame. The scope of the present disclosure is not limited in this respect.

In some embodiments, the at least one packet may comprise a plurality of packets. In such a case, the first indication is comprised in a first packet of the plurality of packets. The first packet is generated before the rest, e.g., a remainder, of the plurality of packets. Thereby, it is possible to reduce overhead.

In some embodiments, the first indication may be implemented as a header extension. In one example, the header extension is of a one-byte header format, which has been described in detail in the above section 2.3. Alternatively, the header extension is of a two-byte header format, which has been described in detail in the above section 2.4.

In some embodiments, a value for the first indication may be determined based on a clock rate associated with the visual data and the difference between the decoding timestamp and the presentation timestamp. By way of example rather than limitation, the value for the first indication may be determined as follows:

$$C T S = \frac{P T S - D T S}{C l k} \qquad ( 1 )$$

where CTS represents the value for the first indication, which is also referred to as composition time herein, PTS represents the decoding timestamp, DTS represents the presentation timestamp, and Clk represents the visual data clock rate. The value for the first indication and the presentation timestamp of the current frame may be encapsulated into the at least one packet. It should be understood that the above illustrations and/or examples are described merely for purpose of description. The scope of the present disclosure is not limited in this respect.

In some embodiments, the bitstream may be obtained from an encoder which encodes the current frame into the bitstream. Alternatively, the bitstream may be extracted from at least one further packet of the current frame in accordance with a further protocol different from the RTP. It should be understood that the bitstream may also be obtained in any other suitable manner. The scope of the present disclosure is not limited in this respect.

In some embodiments, the first indication may be encrypted. In case that the first indication is a header extension, the header extension is encrypted based on a header extension encryption mechanism. Alternatively, the header extension is encrypted a lower-level security and authentication mechanism. It should be understood that the first indication may be encrypted in any other suitable manner. The scope of the present disclosure is not limited in this respect.

The first device 1110 may transmit 1230 the at least one packet to the second device 1120, e.g., during a RTC or WebRTC. After receiving 1235 the at least one packet, the second device 1120 may extract 1240 the bitstream from the at least one packet. In some embodiments, the second device 1120 may extract a value for the first indication and the presentation timestamp of the current frame from the at least one packet. Furthermore, the second device 1120 may determine the decoding timestamp of the current frame based on the presentation timestamp, a clock rate associated with the visual data and the value for the first indication.

By way of example rather than limitation, the decoding timestamp of the current frame may be determined as follows:

$$D T S = P T S - CTS \times Clk \qquad ( 2 )$$

where DTS represents the presentation timestamp, PTS represents the decoding timestamp, CTS represents the value for the first indication and Clk represents the visual data clock rate. It should be understood that the above illustrations and/or examples are described merely for purpose of description. The scope of the present disclosure is not limited in this respect.

In some embodiments, before encapsulating 1225 the bitstream into the at least one packet, a handling process may take place so as to declare the support of the first indication. As shown in FIG. 12, the first device 1110 may transmit 1205 a capability indication to the second device 1120. The capability indication indicates that the first device 1110 supports the first indication. After receiving 1210 the capability indication, the second device 1120 may transmit 1215 a further capability indication to the first device 1110, which indicates that the second device 1120 supports the first indication. Moreover, the first device 1110 encapsulates 1225 the bitstream into the at least one packet after receiving 1220 the further capability indication from the second device 1120. By way of example rather than limitation, the capability indication is transmitted in accordance with a session description protocol (SDP). An example attribute line in SDP is as follows: a=extmap:19 uri:ietf:rtc:rtp-hdrext:video:CompositionTime. It should be understood that the above illustrations and/or examples are described merely for purpose of description. The scope of the present disclosure is not limited in this respect.

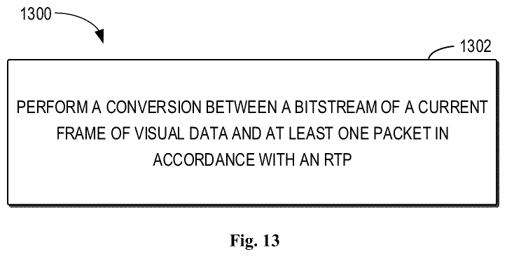

FIG. 13 illustrates a flowchart of a method 1300 for visual data processing in accordance with some embodiments of the present disclosure. For example, the method 1300 may be implemented at either the first device 1110 or the second device 1120 shown in FIG. 11.

At 1302, a conversion between a bitstream of a current frame of visual data and at least one packet is performed in accordance with an RTP. The at least one packet comprises a first indication indicating a difference between a decoding timestamp of the current frame and a presentation timestamp of the current frame. By way of example rather than limitation, the visual data may be a video, a series of images, a multimedia file, or the like. In some embodiments, the current frame may be a bi-directional predicted frame (B-frame). In some embodiments, the conversion may comprise encapsulating the bitstream into the at least one packet. Alternatively, the conversion may comprise extracting the bitstream from the at least one packet. In some embodiments, a communication (such as RTC, WebRTC or the like) may be performed based on the at least one packet.

In aid of the first indication, an RTP-based system can decode visual data with bi-directional predicted frames (B-frames) correctly. Compared with the conversion solutions where only intra-coded frames (I-frames) and predicted frames (P-frames) are supported by an RTP-based system, the proposed method can advantageously enable the RTP-based system to support B-frames and thus improve the compatibility with the state-of-the-art visual data coding technology.

In some embodiments, the at least one packet may comprise a plurality of packets. The first indication may be comprised in a first packet of the plurality of packets. The first packet is generated before the rest of the plurality of packets.

In some embodiments, the first indication may be encrypted. In some embodiments, the first indication may be a header extension. For example, the header extension may be of a one-byte header format or a two-byte header format. The header extension may be encrypted based on a header extension encryption mechanism or a lower-level security and authentication mechanism.

In case that the method is implemented at the first device, a value for the first indication may be determined based on the difference and a clock rate associated with the visual data. At 1302, the value for the first indication and the presentation timestamp of the current frame may be encapsulated into the at least one packet. In some embodiments, the bitstream may be obtained from an encoder encoding the current frame into the bitstream. Alternatively, the bitstream may be extracted from at least one further packet of the current frame in accordance with a further protocol different from the RTP. The first device may transmit, to the second device, a second indication indicating that the first device supports the first indication. Moreover, the first device may receive, from the second device, a third indication indicating that the second device supports the first indication.

In case that the method is implemented at the second device, a value for the first indication and the presentation timestamp of the current frame may be extracted from the at least one packet. Moreover, the decoding timestamp of the current frame may be determined based on the presentation timestamp, a clock rate associated with the visual data and the value for the first indication. In some embodiments, the second device may receive, from the first device, a second indication indicating that the first device supports the first indication. Furthermore, the scone device may transmit, to the first device, a third indication indicating that the second device supports the first indication.

In some embodiments, at least one of the second indication or the third indication may be transmitted in accordance with a session description protocol (SDP).

According to further embodiments of the present disclosure, a non-transitory computer-readable recording medium is provided. The non-transitory computer-readable recording medium stores a bitstream of a current frame of visual data which is generated by a method performed by an apparatus for visual data processing. In the method, a conversion between the bitstream and at least one packet is performed in accordance with an RTP. The at least one packet comprises a first indication indicating a difference between a decoding timestamp of the current frame and a presentation timestamp of the current frame.

According to still further embodiments of the present disclosure, a method for storing bitstream of a current frame of visual data is provided. In the method, a conversion between the bitstream and at least one packet is performed in accordance with an RTP. The at least one packet comprises a first indication indicating a difference between a decoding timestamp of the current frame and a presentation timestamp of the current frame. Moreover, the bitstream is stored in a non-transitory computer-readable recording medium.

According to still further embodiments of the present disclosure, a non-transitory computer-readable recording medium is provided. The non-transitory computer-readable recording medium stores at least one packet which is generated by a method performed by an apparatus for visual data processing. In the method, a conversion between a bitstream of a current frame of visual data and the at least one packet is performed in accordance with an RTP. The at least one packet comprises a first indication indicating a difference between a decoding timestamp of the current frame and a presentation timestamp of the current frame.

According to still further embodiments of the present disclosure, a method for storing at least one packet is proposed. In the method, a conversion between a bitstream of a current frame of visual data and the at least one packet is performed in accordance with an RTP. The at least one packet comprises a first indication indicating a difference between a decoding timestamp of the current frame and a presentation timestamp of the current frame. Moreover, the at least one packet is stored in a non-transitory computer-readable recording medium.

Implementations of the present disclosure can be described in view of the following clauses, the features of which can be combined in any reasonable manner.

Clause 1. A method for visual data processing, comprising: performing a conversion between a bitstream of a current frame of visual data and at least one packet in accordance with a real-time transport protocol (RTP), wherein the at least one packet comprises a first indication indicating a difference between a decoding timestamp of the current frame and a presentation timestamp of the current frame.

Clause 2. The method of clause 1, wherein the first indication is encrypted.

Clause 3. The method of any of clauses 1-2, wherein the at least one packet comprises a plurality of packets, and the first indication is comprised in a first packet of the plurality of packets, the first packet being generated before the rest of the plurality of packets.

Clause 4. The method of any of clauses 1-3, wherein the first indication is a header extension.

Clause 5. The method of clause 4, wherein the header extension is of a one-byte header format or a two-byte header format.

Clause 6. The method of any of clauses 4-5, wherein the header extension is encrypted based on a header extension encryption mechanism or a lower-level security and authentication mechanism.

Clause 7. The method of any of clauses 1-6, wherein the current frame is a bi-directional predicted frame (B-frame).

Clause 8. The method of any of clauses 1-7, wherein the method is implemented at a first device, the method further comprises: determining a value for the first indication based on the difference and a clock rate associated with the visual data, and wherein performing the conversion comprises: encapsulating the value for the first indication and the presentation timestamp of the current frame into the at least one packet.

Clause 9. The method of clause 8, further comprising: obtaining the bitstream from an encoder encoding the current frame into the bitstream.

Clause 10. The method of clause 8, further comprising: extracting the bitstream from at least one further packet of the current frame in accordance with a further protocol different from the RTP.

Clause 11. The method of any of clauses 8-10, further comprising: transmitting, to a second device, a second indication indicating that the first device supports the first indication; and receiving, from the second device, a third indication indicating that the second device supports the first indication.

Clause 12. The method of any of clauses 1-7, wherein the method is implemented at a second device, performing the conversion comprises: extracting a value for the first indication and the presentation timestamp of the current frame from the at least one packet, and the method further comprises: determining the decoding timestamp of the current frame based on the presentation timestamp, a clock rate associated with the visual data and the value for the first indication.

Clause 13. The method of clause 12, further comprising: receiving, from a first device, a second indication indicating that the first device supports the first indication; and transmitting, to the first device, a third indication indicating that the second device supports the first indication.

Clause 14. The method of clause 11 or 13, wherein at least one of the second indication or the third indication is transmitted in accordance with a session description protocol (SDP).

Clause 15. The method of any of clauses 1-7, wherein the conversion comprises encapsulating the bitstream into the at least one packet.

Clause 16. The method of any of clauses 1-7, wherein the conversion comprises extracting the bitstream from the at least one packet.

Clause 17. An apparatus for visual data processing comprising a processor and a non-transitory memory with instructions thereon, wherein the instructions upon execution by the processor, cause the processor to perform a method in accordance with any of clauses 1-16.

Clause 18. A non-transitory computer-readable storage medium storing instructions that cause a processor to perform a method in accordance with any of clauses 1-16.

Clause 19. A non-transitory computer-readable recording medium storing a bitstream of a current frame of visual data which is generated by a method performed by an apparatus for visual data processing, wherein the method comprises: performing a conversion between the bitstream and at least one packet in accordance with a real-time transport protocol (RTP), wherein the at least one packet comprises a first indication indicating a difference between a decoding timestamp of the current frame and a presentation timestamp of the current frame.

Clause 20. A method for storing a bitstream of a current frame of visual data, comprising: performing a conversion between the bitstream and at least one packet in accordance with a real-time transport protocol (RTP); storing the bitstream in a non-transitory computer-readable recording medium, wherein the at least one packet comprises a first indication indicating a difference between a decoding timestamp of the current frame and a presentation timestamp of the current frame.

Clause 21. A non-transitory computer-readable recording medium storing at least one packet which is generated by a method performed by an apparatus for visual data processing, wherein the method comprises: performing a conversion between a bitstream of a current frame of visual data and the at least one packet in accordance with a real-time transport protocol (RTP), wherein the at least one packet comprises a first indication indicating a difference between a decoding timestamp of the current frame and a presentation timestamp of the current frame.

Clause 22. A method for storing at least one packet, comprising: performing a conversion between a bitstream of a current frame of visual data and the at least one packet in accordance with a real-time transport protocol (RTP); storing the at least one packet in a non-transitory computer-readable recording medium, wherein the at least one packet comprises a first indication indicating a difference between a decoding timestamp of the current frame and a presentation timestamp of the current frame.

### Example Device

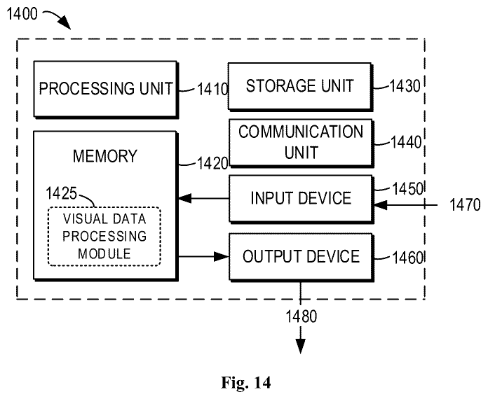

FIG. 14 illustrates a block diagram of a computing device 1400 in which various embodiments of the present disclosure can be implemented. The computing device 1400 may be implemented as or included in the source device 110 (or the RTP unit 113) or the destination device 120 (or the RTP unit 123).

It would be appreciated that the computing device 1400 shown in FIG. 14 is merely for purpose of illustration, without suggesting any limitation to the functions and scopes of the embodiments of the present disclosure in any manner.

As shown in FIG. 14, the computing device 1400 includes a general-purpose computing device 1400. The computing device 1400 may at least comprise one or more processors or processing units 1410, a memory 1420, a storage unit 1430, one or more communication units 1440, one or more input devices 1450, and one or more output devices 1460.

In some embodiments, the computing device 1400 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1400 can support any type of interface to a user (such as “wearable” circuitry and the like).

The processing unit 1410 may be a physical or virtual processor and can implement various processes based on programs stored in the memory 1420. In a multi-processor system, multiple processing units execute computer executable instructions in parallel so as to improve the parallel processing capability of the computing device 1400. The processing unit 1410 may also be referred to as a central processing unit (CPU), a microprocessor, a controller or a microcontroller.

The computing device 1400 typically includes various computer storage medium. Such medium can be any medium accessible by the computing device 1400, including, but not limited to, volatile and non-volatile medium, or detachable and non-detachable medium. The memory 1420 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1430 may be any detachable or non-detachable medium and may include a machine-readable medium such as a memory, flash memory drive, magnetic disk or another other media, which can be used for storing information and/or data and can be accessed in the computing device 1400.

The computing device 1400 may further include additional detachable/non-detachable, volatile/non-volatile memory medium. Although not shown in FIG. 14, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1440 communicates with a further computing device via the communication medium. In addition, the functions of the components in the computing device 1400 can be implemented by a single computing cluster or multiple computing machines that can communicate via communication connections. Therefore, the computing device 1400 can operate in a networked environment using a logical connection with one or more other servers, networked personal computers (PCs) or further general network nodes.

The input device 1450 may be one or more of a variety of input devices, such as a mouse, keyboard, tracking ball, voice-input device, and the like. The output device 1460 may be one or more of a variety of output devices, such as a display, loudspeaker, printer, and the like. By means of the communication unit 1440, the computing device 1400 can further communicate with one or more external devices (not shown) such as the storage devices and display device, with one or more devices enabling the user to interact with the computing device 1400, or any devices (such as a network card, a modem and the like) enabling the computing device 1400 to communicate with one or more other computing devices, if required. Such communication can be performed via input/output (I/O) interfaces (not shown).

In some embodiments, instead of being integrated in a single device, some or all components of the computing device 1400 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1400 may be used to implement video processing in embodiments of the present disclosure. The memory 1420 may include one or more visual data processing modules 1425 having one or more program instructions. These modules are accessible and executable by the processing unit 1410 to perform the functionalities of the various embodiments described herein.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
performing a conversion between a bitstream of a current frame of visual data and at least one packet in accordance with a real-time transport protocol (RTP),
wherein the at least one packet comprises a first indication indicating a difference between a decoding timestamp of the current frame and a presentation timestamp of the current frame.

2. The method of claim 1, wherein the first indication is encrypted.

3. The method of claim 1, wherein the at least one packet comprises a plurality of packets, and the first indication is comprised in a first packet of the plurality of packets, the first packet being generated before a remainder of the plurality of packets.

4. The method of claim 1, wherein the first indication is a header extension.

5. The method of claim 4, wherein the header extension is of a one-byte header format or a two-byte header format.

6. The method of claim 4, wherein the header extension is encrypted based on a header extension encryption mechanism or a lower-level security and authentication mechanism.

7. The method of claim 1, wherein the current frame is a bi-directional predicted frame (B-frame).

8. The method of claim 1, wherein the method is implemented at a first device, the method further comprises:
determining a value for the first indication based on the difference and a clock rate associated with the visual data, and
wherein performing the conversion comprises:
encapsulating the value for the first indication and the presentation timestamp of the current frame into the at least one packet.

9. The method of claim 8, further comprising:
obtaining the bitstream from an encoder encoding the current frame into the bitstream.

10. The method of claim 8, further comprising:
extracting the bitstream from at least one further packet of the current frame in accordance with a further protocol different from the RTP.

11. The method of claim 8, further comprising:
transmitting, to a second device, a second indication indicating that the first device supports the first indication; and
receiving, from the second device, a third indication indicating that the second device supports the first indication.

12. The method of claim 1, wherein the method is implemented at a second device, performing the conversion comprises:
extracting a value for the first indication and the presentation timestamp of the current frame from the at least one packet, and
the method further comprises:
determining the decoding timestamp of the current frame based on the presentation timestamp, a clock rate associated with the visual data and the value for the first indication.

13. The method of claim 12, further comprising:
receiving, from a first device, a second indication indicating that the first device supports the first indication; and
transmitting, to the first device, a third indication indicating that the second device supports the first indication.

14. The method of claim 11, wherein at least one of the second indication or the third indication is transmitted in accordance with a session description protocol (SDP).

15. The method of claim 13, wherein at least one of the second indication or the third indication is transmitted in accordance with a session description protocol (SDP).

16. The method of claim 1, wherein the conversion comprises encapsulating the bitstream into the at least one packet.

17. The method of claim 1, wherein the conversion comprises extracting the bitstream from the at least one packet.

18. An apparatus for visual data processing comprising a processor and a non-transitory memory with instructions thereon, wherein the instructions upon execution by the processor, cause the processor to perform acts comprising:
performing a conversion between a bitstream of a current frame of visual data and at least one packet in accordance with a real-time transport protocol (RTP),
wherein the at least one packet comprises a first indication indicating a difference between a decoding timestamp of the current frame and a presentation timestamp of the current frame.

19. A non-transitory computer-readable storage medium storing instructions that cause a processor to perform acts comprising:
performing a conversion between a bitstream of a current frame of visual data and at least one packet in accordance with a real-time transport protocol (RTP),
wherein the at least one packet comprises a first indication indicating a difference between a decoding timestamp of the current frame and a presentation timestamp of the current frame.

20. A non-transitory computer-readable recording medium storing at least one packet which is generated by a method performed by an apparatus for visual data processing, wherein the method comprises:
performing a conversion between a bitstream of a current frame of visual data and the at least one packet in accordance with a real-time transport protocol (RTP),
wherein the at least one packet comprises a first indication indicating a difference between a decoding timestamp of the current frame and a presentation timestamp of the current frame.
